(19) United States
(12) Patent Application Publication
(10) Pub. No.: US 2011/0307219 A1
(43) Pub. Date: Dec. 15, 2011

(54) METHOD FOR DIAGNOSTIC MONITORING

(76) Inventors: Frank Szemkus, Berkenthin (DE); Gernot Pohlmann, Curau (DE)

(21) Appl. No.: 13/062,683

(22) PCT Filed: Sep. 4, 2009
(86) PCT No.: PCT/EP09/06425

§ 371 Date: Aug. 30, 2011

(30) Foreign Application Priority Data
Sep. 6, 2008 (DE) 10 2008 046 156.3

(51) Int. Cl. G06F 15/00

(52) U.S. Cl. 702/185

(57) ABSTRACT

In order to provide a method for the diagnostic monitoring of the operating states of a plurality of technical systems (1) distribued among different locations, particularly wind energy plants, by means of receiving status codes (19) output by at least on e memory programmable control system (SPS) (5, 6) disposed on the system side, wherein an exchange of information is carried out with remote monitoring units (160, 170, 15, 16, 17) that are disposed outside of the technical systems (1) and at a distance thereto and configured separately, which enables the integration, even subsequently, of a wide variety of systems to be monitored regardless of a central service provider in an error-tolerant and flexible manner, according to the invention operating data is associated with each status code (19) on the system side for analyzing the status code (19), a complex status signal (11) is subsequently generated from one or more status codes (19) and the associated operating data, and the complex status signal (11) is transmitted to the remote monitoring units (160, 170, 15, 16, 17) as part of the exchange of information.

### CROSS-REFERENCE TO RELATED APPLICATIONS

Priority is claimed to PCT/EP2009/006425, filed on Sep. 4, 2009, and German Application No. 10 2008 046 156.3 filed Sep. 6, 2008. Both of these applications are incorporated herein by reference.

The present invention relates to a method for the diagnostic monitoring of the operating state of a plurality of technical machines, in particular wind turbines, distributed among different locations by receiving status codes output by at least one programmable logic control (PLC) system arranged on the machine side, an exchange of information being carried out with remote monitoring units which are arranged outside the technical machines, at a distance therefrom, and are constructed separately.

Methods of this type for diagnostic monitoring are used, in particular, for the real-time transmission of alarm messages as a basic prerequisite for ensuring the availability of machines such as wind turbines. Subscribers to corresponding alarm networks may be both people, such as service staff or engineers, and computers/communication systems, such as alarm servers and monitoring systems.

The known methods for diagnostic monitoring can be roughly divided into those having a substantially decentralised architecture and those having a substantially centralised architecture.

In the case of the known decentralised architectures, for example machine messages, say from wind turbines, are transmitted for example via the telephone network via temporary dial-up connections. For example, in the case of a known decentralised monitoring method, the signal is transmitted on the machine side to a specific terminal of an industrial modem and is sent, for example via SMS, to an external communication partner. The received signal has to be interpreted by the communication partner. This generally and disadvantageously presupposes knowledge of the details of the machine-side PLC emitting the signal.

Although known diagnostic methods of this type have the advantage that they are independent of a central communication service provider and that there is no single point of failure which could make the entire machine monitoring process impossible, a drawback of the known decentralised monitoring methods is that the cost of maintaining the transmission of the machine messages increases sharply with the number of machines to be monitored, messages to be sent and communication channels used, as well as monitoring subscribers present in the network. The interpretation of the received signals often presupposes detailed technical information, such as status code lists, regarding the machine-side PLC. This means, disadvantageously, that scaling of the machines, i.e. in particular a retrospective addition of further machines, may entail costly adaptations of the monitoring system and monitoring method. Problems may arise, particularly if PLCs from different manufacturers are used in the different technical machines.

On the other hand, generic methods for diagnostic monitoring are known which are based on centralised communication. In this instance, machines and farms send their messages to a central external communication node which is tasked with sending the message to selected communication partners via determined paths. A drawback of this type of diagnosis monitoring is the centralised construction, which may lead to a failure of the entire monitoring process if problems occur at the central external communication node. A further disadvantage is that scaling of the monitoring system, i.e. the addition of additional machines to be monitored, is often very costly owing to the high administrative cost on the part of the central server.

A further drawback of the known diagnostic monitoring methods is that efficient error analysis using the error code emitted by the PLC is often not possible without additional data from or about the PLC.

Furthermore, with known diagnostic methods of the aforementioned type, many surprising machine states which occur during adaptation of the monitoring method can only be taken into account by reprogramming the PLC systems. This is time-consuming and therefore, disadvantageously, does not constitute a suitable measure when events occur suddenly which require a change to the monitoring routine.

On this basis, the object of the present invention is to provide a method for diagnostic monitoring of the type mentioned at the outset which makes it possible, even retrospectively, to integrate a wide range of machines to be monitored, irrespectively of a central service provider, in an error-tolerant and versatile manner.

In accordance with the invention, this object is achieved by a method of the aforementioned type, in which operating data for analysing the status code are associated with each status code on the machine side, a complex status signal which characterises the PLC outputting the status code and/or the operating state is subsequently generated from one or more status codes and the associated operating data, and the complex status signal is transmitted to the remote monitoring units during the exchange of information. The method thus constitutes a type of compromise between a completely decentralised monitoring method and completely centralised monitoring, since the raw status codes are processed on the machine side. Standardisation of the information transmitted to the external remote monitoring units is thus advantageously ensured. The status signals generated and transmitted in accordance with the invention are themselves comprehensible information packets which can be supplied to a separate analysis without additional technical data or the like. In particular, the operator-specific information regarding the corresponding PLC, from which the raw signal originates, can also be contained in each complex status signal in a form which is uniform for all complex status signals and desired by the operator.

In an advantageous configuration of the invention it is provided for the operating data to be extracted from a database which is available on the machine side, the operating data relating in particular to statistical data of the technical machine. The database may be stored, for example, on a hard drive within a wind turbine. The operating data may include, for example, a time stamp and a plain text error protocol which is associated with the respective status code of the PLC. In particular, statistical data relating to individual operating parameters of this machine, for example values average over a period of 10 minutes, can also be extracted from the database. In accordance with the invention, all data which depend specifically on the PLC used can thus be deposited within the machine-side database in order to correctly read out the PLC. The complex status signal generated on this basis is standardised in accordance with the invention i.e. independently of the specific PLC and the specific format of the status code emitted by this PLC.

In a further advantageous configuration of the method according to the invention the operating data are extracted, preferably via remote data transmission, in particular by an ftp and/or http protocol, from an operating database which is spatially removed from the location of the technical machine, the operating data relating in particular to statistical data of the technical machine. For example, the operating database may be provided by the PLC manufacturer. When replacing the machine-side PLC, adaptation of the database provided on the machine side is unnecessary in this embodiment of the method. Instead, current operating data, for example for interpretation of the status code emitted by a PLC, are extracted online from the external operating database.

In an advantageous configuration of the invention the operating data are polled from a machine-side controller (PLC), the operating data relating in particular to real-time data of the technical machine. Real-time data which have been generated by the PLC can thus be added to the complex status signal.

In a development of the invention it is provided for operating data of a plurality of controllers, preferably associated with different technical machines, to be polled. In accordance with the invention, a sequence of further status codes of other PLCs can thus be polled and integrated into the complex status signal once a status code which has been released by a PLC has been input using a set of rules. In accordance with the invention for example, spatially diffused events can thus be communicated to other machines of a machine assembly. A type of early warning system is thus advantageously obtained. For example, within a wind farm a complex status signal regarding icing of one machine could be enhanced with information about the icing of other machines within the same farm.

If rules for sequence control of the diagnostic monitoring process are read out from a machine-side database, it is then possible in a further advantageous configuration of the invention to implement a monitoring strategy on the machine side. This can be adapted to the specific parameters of the technical machine to be monitored and of the PLC provided therein. For example, the release of the exchange of information to the remote monitoring units can be determined as part of the sequence control.

The status signal and/or the exchange of information can be generated, in accordance with the invention, in a time-controlled manner. For example, a status signal can be generated within a predetermined period for carrying out frequency analyses of machine states and transmitted to remote monitoring units.

In another configuration of the invention the status signal and/or the exchange of information is generated in an event-controlled manner. For example, a status signal is generated and sent on the machine side using status codes received from the PLC, but only in the presence of specific value constellations of the operating data.

In a further configuration of the method according to the invention the status signals can be stored in a machine-side status database and/or in an external status database. For example, a local status database on the output side can store the last status signal and use it to initialise external remote monitoring units. The external or machine-side status database can also be used to store all received status signals within a configurable period. This makes it possible to provide, for example, frequency analysis of specific machine states or else status code histories which can then be analysed by external monitoring clients.

In a specific configuration of the invention the operating data are extracted from the machine-side status database (13) and/or from the external status database (16), the operating data relating in particular to status signals generated in a previous step. As a result of this, trend information for example can advantageously be derived from earlier status signals by comparison with current status signals.

In a development of the invention the machine-side status database and/or the external status database is/are integrated into the database which is available on the machine side in order to simplify the data architecture.

In a preferred configuration of the invention the information is exchanged via a wide area network (WAN), in particular the Internet.

In a development of the invention it is provided for the complex status signal (11) additionally to be generated from a further complex status signal, in particular a further technical machine. Within the scope of the invention status signals from accessible status signal generators can thus also be received and intercepted and processed as input-side status codes in addition to the status codes emitted by the PLC. Status signals of subordinate primary status signal generators are thus also intercepted as input-side status codes and processed using the set of rules of the secondary status signal generator and transformed into secondary status signals. Two status signal generators are thus virtually cascaded or connected in series. The invention will be described by way of example in a preferred embodiment with reference to drawings, wherein further advantageous details of the figures are to be inferred from the drawings.

Functionally like components are provided with like reference numerals.

More specifically, in the figures:

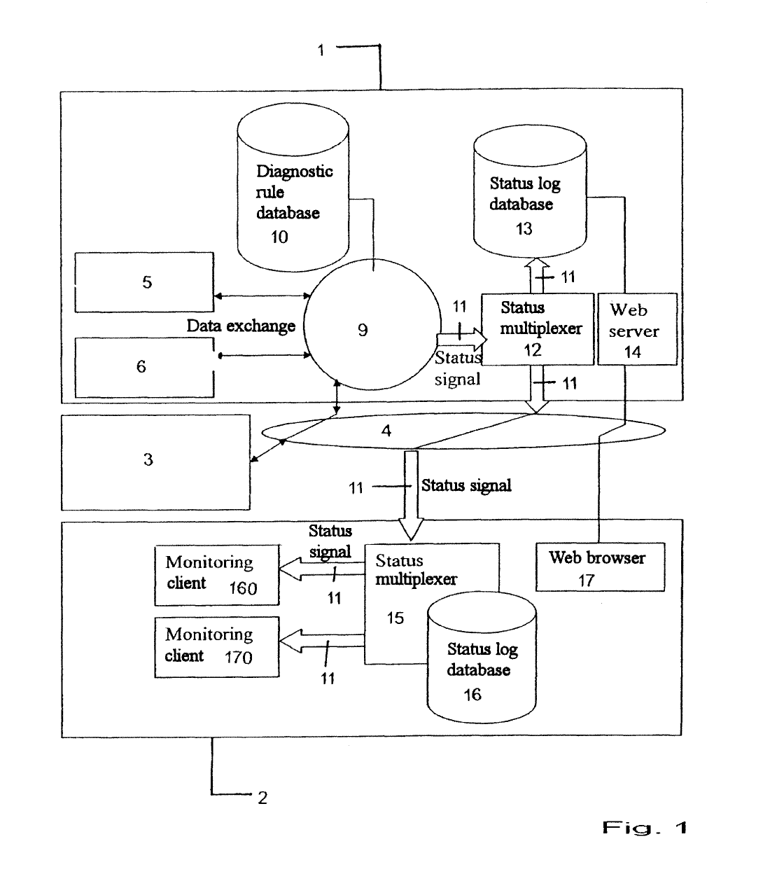

FIG. 1: is a schematic diagram illustrating the information paths and spatial arrangement of components in the configuration of a method according to the invention;

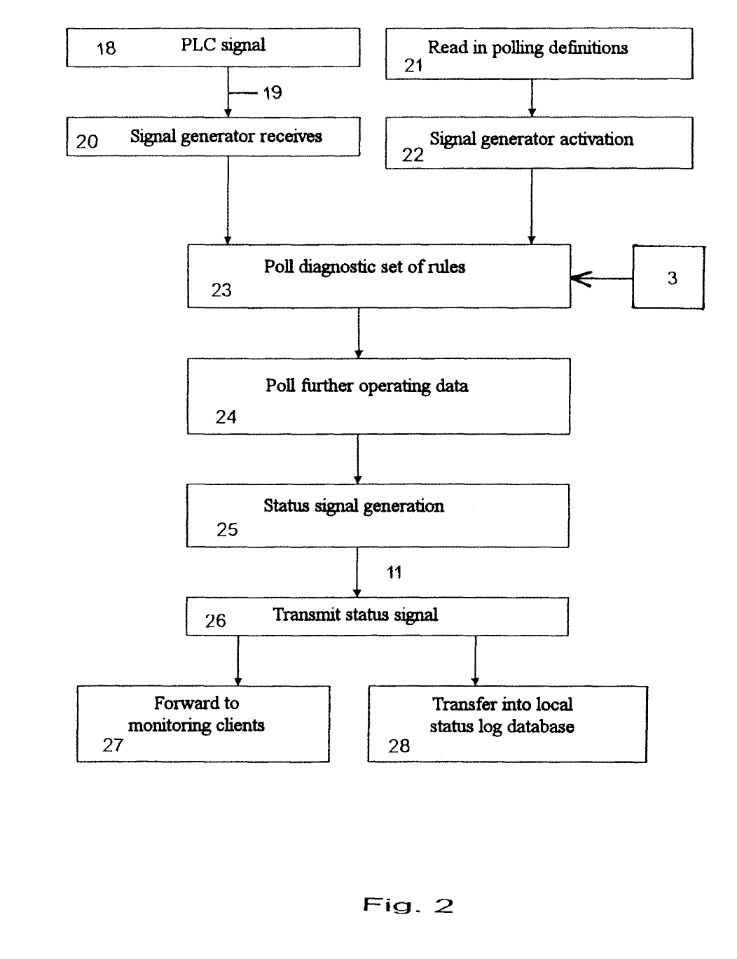

FIG. 2: is a flow chart illustrating the sequence of a diagnostic method according to the invention;

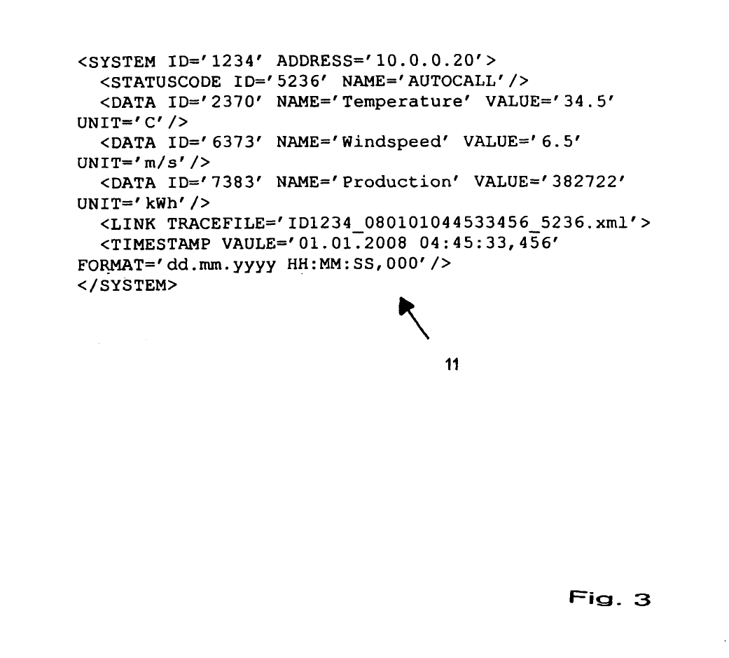

FIG. 3: is an example of a complex status signal in XML format in accordance with the method according to the invention;

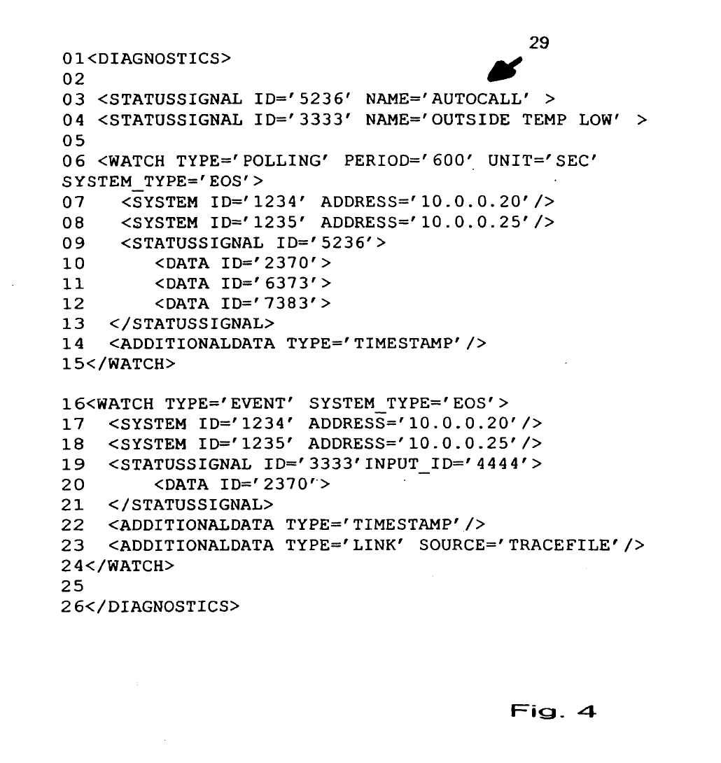

FIG. 4: is an example of a rule stored in XML format for sequence control in accordance with the invention of the diagnostic monitoring process.

FIG. 1 schematically shows the primary spatial arrangement of the data flows during use of the method according to the invention. The technical machine 1 can be seen in principle. The region 2 of the subscriber to the alarm network and an external data provision system 3 at a third location are spatially separated from the technical machine 1. The Internet 4 via which data can be exchanged between the technical machine 1, the subscriber region 2 and the external data provision system 3 is also shown schematically. In particular, the machine is a wind turbine.

PLC systems 5, 6 are arranged within the technical machine 1. The PLC systems 5, 6 communicate via data channels 7, 8 with a status signal generator 9. The status signal generator 9 is configured as a separate service on a computer in the machine side. Data is exchanged between the status signal generator 9 and diagnostic rule database 10. Rules for the sequence for the diagnostic method are stored in the diagnostic rule database 10. Furthermore, the operating data identifiers are stored in the diagnostic rule database 10 via the PLC systems 5, 6 in order to enable a rule-based data exchange with the PLC. The diagnostic rule database 10 is also formed on a computer on the side of the technical machine 1.

A status signal 11 generated by the status signal generator 9 is distributed to different receivers via a status signal multiplexer 12. The status signal 11 is selectively distributed via the status signal multiplexer 12 to a machine-side status signal log database 13 or via the Internet 4 into the subscriber region 2. The status signal log database 13 is connected to the subscriber region 2 via a machine-side web server 14 and also via the Internet 4 for data exchange.

A status signal multiplexer 15 on the subscriber region side is used to distribute the status signal received via the Internet 4 within the subscriber region 2. The status signal multiplexer 15 distributes the status signal 11 to monitoring clients 16, 17 and to a subscriber-side status signal log database 16. Furthermore, on the subscriber side a web browser 17 is used to read out the status signal log database 13 on the part of the technical machine 1 via the Internet 4 and the web server 14. This function can be used in addition to the subscriber-side status signal log database 16.

The method according to the invention for diagnostic monitoring of the operating state of a plurality of technical machines 1 distributed among different locations will be outlined hereinafter with reference to FIG. 1.

The status signal generator 9 obtains information from the diagnostic rule database 10 regarding the sequence of diagnosis operations to be carried out. For example, a rule which stipulates a specific polling interval is stored in the diagnostic rule database 10. In accordance with this polling rule, the status signal generator 9 receives respective rule status codes from the PLC systems 5, 6 via the data channels 7. The status signal generator 9 can thus read out specific operating data of the monitored machine.

With reference to rules stored in the diagnostic rule database 10 regarding the PLC systems read out, the status codes present in rule format are now identified, for example with a standardised plain text error message. For example, the error message may be generated in German, English, Chinese and/or another language. The diagnostic rule database 10 may contain, for example, rules relating to the polling of further data. The polling of real-time data from the PLC and/or the polling of statistical data, for example a 10-minute average, from a database may thus generally be required. The status signal generator 9 subsequently generates the complex status signal 11 from this data. The status signal 11 is then present in a standardised form which is independent of the read-out PLC 5, 6. The status signal 11 is itself also comprehensible since it contains all the information regarding the error message and the location of the error.

The status signal 11 generated in this manner is now fed via the status signal multiplexer 12 on the one hand to the status signal log database 13 where, for example, a plurality of status signals 11 generated in succession can be stored. On the other hand, the status signal is transmitted via the status signal multiplexer 12, through the Internet 4 to the subscriber-side status signal multiplexer 15 in the subscriber region 2. From there it is transmitted to the monitoring clients 16, 17 to allow monitoring of the distributed technical machine. Forwarding of the status signal 11 via the status signal multiplexer 15 to the status signal log database 16 in the subscriber region 2 makes it possible, additionally or alternatively to the storage in the machine-side status signal log database 13, centrally to detect the status signals over a period of time.

The chronological sequence of the method steps carried out in the status signal generator 9 in order to generate the status signal 11 will be illustrated in detail hereinafter with reference to FIG. 2.

The following method steps are carried out first, substantially simultaneously. In a method step 18 a PLC system 5, 6 emits a raw status code 19 which is received by the status signal generator 9 in step 20. At the same time, the status signal generator 9 reads out the diagnostic set of rules from the diagnostic rule database 10 in step 21. This provides the information as to how the status signal generator 9 is to convert a status code 19 received from one of the PLC systems 5, 6 into a status signal 11.

In the exemplary sequence of events shown in FIG. 2, the diagnostic set of rules relates to a polling definition. In step 2, the signal generator 9 is accordingly activated to poll specific operating data according to step 20 once the polling time according to the diagnostic rule read out in step 21 has been reached.

In step 23 the signal generator 9 polls further operating data from the diagnostic rule database 10 in step 23, which data belong to the status code 19 and the emitting PLC systems 5, 6.

As defined in the diagnostic rule database, the signal generator 9 receives real-time data from the PLC in step 24 and, in step 23, receives data from an external or internal data provision system 3 in order to generate a status signal 11 therefrom in step 25. The data from the data provision system 3 may include individual values, time series or spectra or else digital media contents such as images or sounds or else external prediction values.

Lastly, the signal generator 9 sends the generated status signal 11 to the different receiving channels in the next step 26. In step 27, the status signal 11 is forwarded via the status signal multiplexer 12 and the Internet 4 to the monitoring client 16, 17 in the subscriber region 2. In step 28 the status signal 11 is fed simultaneously via the status signal multiplexer 12 into the machine-side status signal log database 13.

Referring to FIG. 3, a status signal 11 provided in XML format is explained by way of example. The XML tags used in the status signal 11 are allocated as follows:

<SYSTEM> control system-ID (ID), address

<STATUSCODE> status identifier (ID), name, timestamp

<DATA> operating data identifier (ID), operating data name, value, unit

<LINK> address/name of the corresponding trace file

<TIMESTAMP> timestamp (value) with format.

The information required to identify the controller is thus contained in the status signal 11 described by way of example in FIG. 3 in the form of the control system ID and the corresponding logical address. Furthermore, the operating data names are contained in the plain text as temperature, wind speed and production, and the units are also contained. Lastly, the logical address of a trace file and a time stamp are provided. The status signal 11 which is generated in this manner by the method according to the invention through use of the status signal generator is thus present in a standardised form which can be interpreted independently of technical details regarding the PLC 5, 6 which is emitting the status code. The status signal 11 is thus readily suitable for centralised data analysis in the subscriber region 2.

FIG. 4 shows in XML format an example of a diagnostic set of rules which is stored in the machine-side diagnosis database 10. The diagnostic rule according to FIG. 4, denoted generally by reference numeral 29, is delimited by the external XML tag “diagnostics” in lines 01 and 026. Lines 03 to 04 contain definitions of two status signals. What is known as a polling query, i.e. a periodic polling of data in the 10-minute interval, i.e. the 600 second interval, is defined for “EOS” type machines in line 6. Lines 7 to 8 contain a list of the monitored PLC systems 5, 6 with the associated logical addresses. The status signal of the ID 5236 for the “autocall” function is defined in line 9 with the possible operating data identifiers “2370”, 6373” and “7383”. The operating data identifiers each reference specific operating data which are polled by the PLC during the polling process and embedded in the status signal. It is finally established in line 14 that all status signals are additionally provided with a time stamp.

The monitoring rule “event”, with which a received status code of a PLC is transformed into a status signal by the status signal generator is defined in lines 16 to 24. According to the definition in line 16, this applies to all PLC systems of the EOS type. Lines 17 to 18 contain a list of the monitored PLC systems 5,6 including logical address. It is defined in line 19 that a status signal “3333” is generated on receipt of the status code “4444”, the status signal generator polling data with the operating data identifier “2370” from the PLC and embedding it in the status signal “3333” generated by it in line 20. In line 22, a time stamp is additionally generated for the status signal. It is established in line 23 that the status code contains a reference to a trace file.

Different monitoring methods may be carried out for diagnosis, using the set of rules 29 shown by way of example in FIG. 4. The set of rules 29 can advantageously be varied on the machine side, without the need to adapt the subscriber region 2. The diagnostic set of rules may be modified, for example, by the user. Modification of the PLC systems 5, 6 is not required for this purpose either.

In the context of the invention, the status signal multiplexer 12 can also distribute the status signal 11 to further status signal multiplexers, to a mail server and/or to an SMS server. The status signal can also be displayed at the monitoring client 16, 17, for example including the operating data contained therein.

Communication between the PLC systems 5, 6, the status signal generator 9, the status signal multiplexer 12, the external data provision systems 3 and the monitoring client 16, 17 can take place via TCP/IP-based web service technology. SOAP (simple object access protocol) is suitable in particular.

A method for the diagnostic monitoring of the operating state of a plurality of technical machines, in particular wind turbines, distributed among different locations is accordingly proposed, which generates standardised status signals 11 by means of machine-side processing of the status codes emitted by the PLC systems 5, 6. The standardised status signals are very suitable, in particular, for integration in an analysis by a subscriber region 2. Standardisation allows the system to be scaled in a straightforward manner, in particular allows a subsequent addition of further technical machines which are to be monitored.

### LIST OF REFERENCE NUMERALS

1. technical machine

2. subscriber region

3. external data provision system

4. Internet

5. PLC system

6. PLC system

7. data channel

8. data channel

9. status signal generator

10. diagnostic rule database

11. status signal

12. status signal multiplexer (machine-side)

13. status signal log database

14. web server

15. status signal multiplexer (subscriber-side)

16. status signal log database (subscriber-side)

160 monitoring client

170 monitoring client

17. web browser

18. PLC transmits signal

19. status code

20. status signal generator receives status code

21. method step read-out of diagnostic set of rules

22. method step activation of signal generator

23. method step requesting operating data from the diagnostic rule database and from the external data provision system

24. method step receiving operating data from the diagnostic rule database and from the external data provision system

25. method step generation of a status signal

26. method step transmission of the status signal

27. method step forwarding of the status signal to the monitoring client

28. method step introduction of the status signal into the machine-side status signal log database

29. diagnostic rule

1. Method for the diagnostic monitoring of the operating state of a plurality of technical machines (1), in particular wind turbines, distributed among different locations by receiving status codes (19) output by at least one programmable logic control (PLC) system (5, 6) arranged on the machine side, an exchange of information being carried out with remote monitoring units (160, 170, 15, 16, 17) which are arranged outside the technical machines (1), at a distance therefrom, and are constructed separately, characterised in that operating data for analysing the status code (19) are associated with each status code (19) on the machine side, a complex status signal (11) which characterises the PLC outputting the status code and/or the operating state is subsequently generated from one or more status codes (19) and the associated operating data, and the complex status signal (11) is transmitted to the remote monitoring units (160, 170, 15, 16, 17) during the exchange of information.

2. Method according to claim 1, characterised in that the operating data are extracted from a database (3) which is available on the machine side, the operating data relating in particular to statistical data of the technical machine.

3. Method according to either claim 1 or claim 2, characterised in that the operating data are extracted, preferably via remote data transmission, in particular by an ftp and/or http protocol, from an operating database (3) which is spatially removal from the location of the technical machine (1), the operating data relating in particular to statistical data of the technical machine.

4. Method according to any one of claims 1 to 3, characterised in that the operating data are polled from a machine-side controller (PLC), the operating data relating in particular to real-time data of the technical machine.

5. Method according to claim 4, characterised in that operating data of a plurality of controllers (PLC), preferably associated with different technical machines (1), are polled.

6. Method according to any one of the preceding claims, characterised in that rules (29) for sequence control of the diagnostic monitoring are read out from a machine-side database (10).

7. Method according to claim 4, characterised in that the rules (29) are read out from an XML file.

8. Method according to any one of the preceding claims, characterised in that the status signal (11) and/or the exchange of information is generated in a time-controlled manner.

9. Method according to any one of the preceding claims, characterised in that the status signal (11) and/or the exchange of information is generated in an event-controlled manner.

10. Method according to any one of the preceding claims, characterised in that the status signals (11) are stored in a machine-side status database (13) and/or in an external status (16) database.

11. Method according to claim 10, characterised in that the operating data are extracted from the machine-side status database (13) and/or from the external status database (16), the operating data relating in particular to status signals generated in a previous step.

12. Method according to either claim 10 or claim 11, characterised in that the machine-side status database (13) and/or the external status database (16) is/are integrated into the database (3) which is available on the machine side.

13. Method according to any one of the preceding claims, characterised in that the information is exchanged via a wide area network (WAN), in particular the Internet (4).

14. Method according to any one of the preceding claims, characterised in that the complex status signal (11) is additionally generated from a further complex status signal, in particular a further technical machine.
